(19) United States
(12) Patent Application Publication
(10) Pub. No.: US 2026/0339131 A1
(43) Pub. Date: Oct. 29, 2026

(54) OPTICAL MODULATOR AND OPTICAL MODULATOR-INTEGRATED LASER DEVICE

(71) Applicant: SUMITOMO ELECTRIC DEVICE INNOVATIONS, INC., Yokohama-shi (JP)

(72) Inventor: Hiromitsu KAWAMURA, Yokohama-shi (JP)

(73) Assignee: SUMITOMO ELECTRIC DEVICE INNOVATIONS, INC., Yokohama-shi (JP)

(21) Appl. No.: 19/655,732

(22) Filed: Apr. 23, 2026

(30) Foreign Application Priority Data
Apr. 25, 2025 (JP) 2025-072913

(51) Int. Cl. G02F 1/015; G02F 1/01

(52) U.S. Cl. CPC G02F 1/0157; G02F 1/0121; G02F 2203/70

(57) ABSTRACT

An optical modulator includes a first optical modulator and a second optical modulator of an electro-absorption type that modulate a first input light and a second input light, respectively, which are obtained by splitting an optical power of light at a splitting ratio of 1:2. A signal ground is connected to a cathode electrode of each of the first optical modulator and the second optical modulator. A first binary electrical signal and a second binary electrical signal obtained by decomposing a binary electrical signal are applied to an anode electrode of the first optical modulator and an anode electrode of the second optical modulator, respectively. A first binary optical signal and a second binary optical signal output from the first optical modulator and the second optical modulator, respectively, are combined with each other to form a four-level optical signal.

### CROSS REFERENCE TO RELATED APPLICATION

Priority is claimed on Japanese Patent Application No. 2025-072913, filed on Apr. 25, 2025, the entire content of which is incorporated herein by reference.

### TECHNICAL FIELD

The present disclosure relates to an optical modulator and an optical modulator–integrated laser device.

### BACKGROUND

Japanese Unexamined Patent Publication No. 2002-277840 discloses an optical modulator–integrated laser device including a laser emitter and an optical modulator of an electro-absorption type. The optical modulator includes an n-electrode and a p-electrode. A positive-phase signal and an inverted-phase signal constituting a differential signal are input to the n-electrode and the p-electrode, respectively.

### SUMMARY

An optical modulator according to one embodiment of the present disclosure includes a first optical modulator and a second optical modulator of an electro-absorption type that modulate a first input light and a second input light, respectively, which are obtained by splitting an optical power of light at a splitting ratio of 1:2. A signal ground is connected to a cathode electrode of each of the first optical modulator and the second optical modulator. A first binary electrical signal and a second binary electrical signal obtained by decomposing a binary electrical signal are applied to an anode electrode of the first optical modulator and an anode electrode of the second optical modulator, respectively. A first binary optical signal and a second binary optical signal output from the first optical modulator and the second optical modulator, respectively, are combined with each other to form a four-level optical signal.

### BRIEF DESCRIPTION OF THE DRAWINGS

FIG. 1 is a plan view illustrating an optical modulator-integrated laser device according to an embodiment of the present disclosure.

FIG. 2 is a schematic view illustrating a cross-section taken along line II-II in FIG. 1.

FIG. 3 is a conceptual diagram illustrating a binary electrical signal that is used as the basis for generating a first binary electrical signal and a second binary electrical signal.

FIG. 4 is a diagram illustrating a method for converting the binary electrical signal illustrated in FIG. 3 into a first binary electrical signal and a second binary electrical signal.

FIG. 5 is a conceptual diagram illustrating the first binary electrical signal.

FIG. 6 is a conceptual diagram illustrating the second binary electrical signal.

FIG. 7 is a diagram illustrating the optical power of a modulated first light output from a first optical modulator.

FIG. 8 is a diagram illustrating the optical power of a modulated second light output from a second optical modulator.

FIG. 9 is a diagram illustrating the optical power of output light from an optical combiner.

FIG. 10 is a plan view illustrating a laser device according to a comparative example.

FIG. 11 is a diagram for explaining an S/N ratio.

FIG. 12 is a diagram for explaining an S/N ratio.

FIG. 13 is a diagram for explaining an S/N ratio.

FIG. 14 is a diagram for explaining an S/N ratio.

FIG. 15 is a plan view illustrating a laser device according to a first modification example.

FIG. 16 is a plan view illustrating a laser device according to a second modification example.

FIG. 17 is a plan view illustrating a laser device according to a third modification example.

FIG. 18 is a diagram illustrating a method for converting a binary electrical signal into a first binary electrical signal, a second binary electrical signal, and a third binary electrical signal.

FIG. 19 is a diagram illustrating the optical power of output light from an optical combiner.

FIGS. 20A and 20B are diagrams illustrating an optical splitter and an optical combiner, each including a Y-shaped optical waveguide.

FIG. 21 is a plan view illustrating a laser device including a semiconductor optical amplifier.

### DETAILED DESCRIPTION

In recent years, in optical communication systems, in order to increase transmission capacity, optical signals modulated by a multilevel pulse amplitude modulation method such as PAM4 have increasingly been used. Generally, when an optical signal of a multilevel pulse amplitude modulation method is generated using an optical modulator of an electro-absorption type, the optical modulator of the electro-absorption type is driven by a modulation signal modulated according to the multilevel pulse amplitude modulation method. However, when multilevel pulse amplitude modulation is performed using such a driving method, the signal-to-noise ratio (S/N ratio) decreases compared to a conventional pulse modulation method using only binary values (on/off) (NRZ). As a result, communication quality measured by indices such as transmitter and dispersion eye closure Quaternary (TDECQ) is degraded. An object of the present disclosure is to provide an optical modulator and an optical modulator–integrated laser device capable of performing multilevel pulse amplitude modulation while suppressing a decrease in the S/N ratio.

### DESCRIPTION OF EMBODIMENTS OF THE PRESENT DISCLOSURE

First, the contents of an embodiment of the present disclosure will be listed and described. [1] An optical modulator according to one embodiment of the present disclosure includes a first optical modulator and a second optical modulator of an electro-absorption type that modulate a first input light and a second input light, respectively, which are obtained by splitting an optical power of light at a splitting ratio of 1:2. A signal ground is connected to a cathode electrode of each of the first optical modulator and the second optical modulator. A first binary electrical signal and a second binary electrical signal obtained by decomposing a binary electrical signal are applied to an anode electrode of the first optical modulator and an anode electrode of the second optical modulator, respectively. A first binary optical signal and a second binary optical signal output from the first optical modulator and the second optical modulator, respectively, are combined with each other to form a four-level optical signal.

[2] An optical modulator according to one embodiment of the present disclosure includes a first optical modulator, a second optical modulator, and a third optical modulator of an electro-absorption type that modulate a first input light, a second input light, and a third input light, respectively, which are obtained by splitting an optical power of light at a splitting ratio of 1:2:4. A signal ground is connected to a cathode electrode of each of the first optical modulator, the second optical modulator, and the third optical modulator. A first binary electrical signal, a second binary electrical signal, and a third binary electrical signal obtained by decomposing a binary electrical signal are applied to anode electrodes of the first optical modulator, the second optical modulator, and the third optical modulator, respectively. A first binary optical signal, a second binary optical signal, and a third binary optical signal output from the first optical modulator, the second optical modulator, and the third optical modulator, respectively, are combined with each other to form an eight-level optical signal.

[3] The optical modulator according to [1] or [2] above may further include an optical splitter that splits the light; an optical combiner that combines the light; and an optical modulator for optical power adjustment provided between the optical splitter and the optical combiner.

[4] In the optical modulator according to [1] above, the first optical modulator and the second optical modulator may be configured to receive differential signals as the first binary electrical signal and the second binary electrical signal, and to modulate the first input light and the second input light, respectively.

[5] In the optical modulator according to [2] above, the first optical modulator, the second optical modulator, and the third optical modulator may be configured to receive differential signals as the first binary electrical signal, the second binary electrical signal, and the third binary electrical signal, and to modulate the first input light, the second input light, and the third input light, respectively.

[6] The optical modulator according to [1] above may further include a substrate that is one of a semi-insulating type, an insulating type, a p-type, or an n-type. Further, the first optical modulator and the second optical modulator may be provided on the substrate.

[7] The optical modulator according to [2] above may further include a substrate that is one of a semi-insulating type, an insulating type, a p-type, or an n-type. Further, the first optical modulator, the second optical modulator, and the third optical modulator may be provided on the substrate.

[8] In the optical modulator according to [3] above, one or both of the optical splitter and the optical combiner may include one of a Y-shaped optical waveguide, a directional coupler, or a multi-mode interference coupler.

[9] In the optical modulator according to any one of [1] to [8] above, each of the first optical modulator and the second optical modulator may be formed of a semiconductor layer including a light absorption layer, and a material of the semiconductor layer may be an InP-based material or an Si-based material.

An optical modulator–integrated laser device according to one embodiment of the present disclosure includes the optical modulator according to [3] above that is provided on the substrate; and a laser emitter that is provided on the substrate, is formed of a semiconductor layer including an active layer, and outputs laser light. The input light of the optical splitter may be the laser light.

The optical modulator–integrated laser device according to above may further include a semiconductor optical amplifier that is provided on the substrate, receives combined light from the optical combiner, and amplifies and outputs the combined light.

An optical modulator according to one embodiment of the present disclosure includes an optical splitter that splits input light into first to N-th lights, N being an integer of two or more; first to N-th optical modulators of an electro-absorption type that modulate, by binary electrical signals, the first to N-th lights output from the optical splitter, respectively; and an optical combiner that combines the first to N-th lights output from the first to N-th optical modulators. An optical power of the n-th light may be 2^{(n - 1)} times an optical power of the first light, n being 2, ..., N. First to N-th binary electrical signals obtained by decomposing a binary electrical signal are provided to the first to N-th optical modulators, respectively, such that output light from the optical combiner includes a multilevel optical signal.

### DETAILS OF EMBODIMENTS OF THE PRESENT DISCLOSURE

A specific example of the present disclosure will be described below with reference to the drawings. The present disclosure is not limited to this example, but is defined by the claims, and it is intended that the present disclosure includes all modifications within the concept and scope equivalent to the claims. In the following description, the same reference signs are assigned to the same elements in the description of the drawings, and redundant descriptions thereof will be omitted. In the following description, the term “connection” refers to an electrical connection.

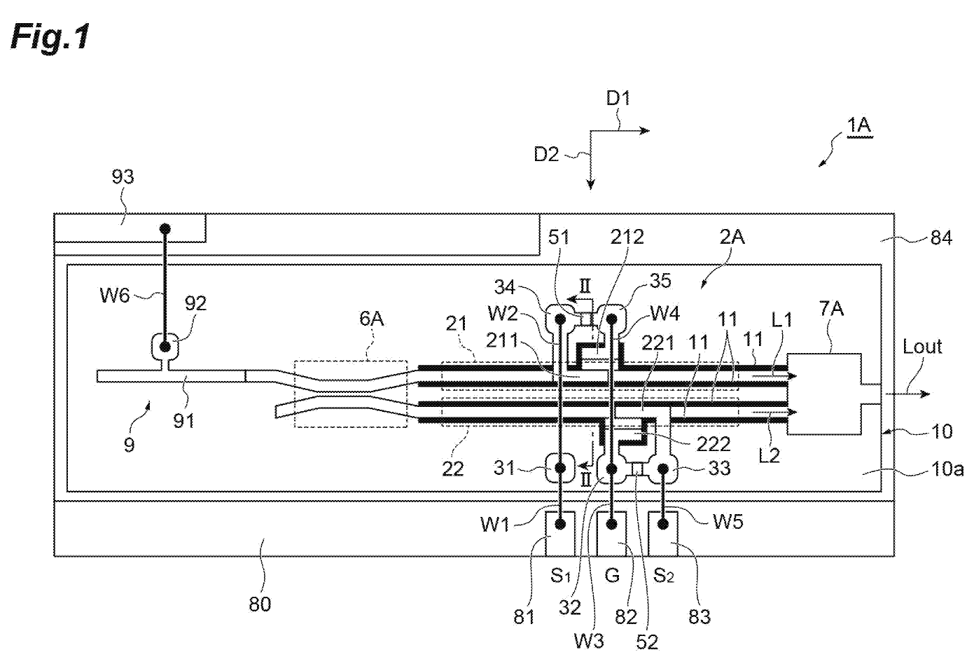

FIG. 1 is a plan view illustrating an optical modulator-integrated laser device (hereinafter, simply referred to as a laser device) 1A according to an embodiment of the present disclosure. The laser device 1A of the present embodiment includes a substrate 10, an optical modulator 2A, and a laser emitter 9. The optical modulator 2A and the laser emitter 9 are monolithically provided on the common substrate 10. The optical modulator 2A and the laser emitter 9 are adjacent to each other along an optical waveguide direction on the substrate 10. The laser emitter 9 outputs laser light. The optical modulator 2A receives laser light from the laser emitter 9. The substrate 10 is one of a semi-insulating type, an insulating type, p-type, or n-type substrate. In one example, the substrate 10 is a semi-insulating InP substrate.

The laser device 1A is mounted on a carrier 80. A ground pattern 84 and a bias pattern 93 are provided on the main surface of the carrier 80. Furthermore, a first signal wiring pattern 81, a ground wiring pattern 82, and a second signal wiring pattern 83 are provided on the main surface of the carrier 80. The laser device 1A is mounted on the ground pattern 84, and the back surface of the laser device 1A is bonded to the ground pattern 84. The first signal wiring pattern 81, the ground wiring pattern 82, the second signal wiring pattern 83, and the bias pattern 93 are disposed at a peripheral edge portion of the ground pattern 84.

The laser emitter 9 includes an electrode 91 and an electrode pad 92. The electrode 91 is an electrode for supplying a bias current to an active layer (not illustrated) of the laser emitter 9. The electrode 91 extends along a first direction D1 (optical waveguide direction). The electrode pad 92 is disposed on a lateral side of the electrode 91, and is connected to the electrode 91. The electrode pad 92 is connected to the bias pattern 93 by a bonding wire W6. A bias current is supplied from the bias pattern 93 to the electrode 91 via the bonding wire W6 and the electrode pad 92.

The optical modulator 2A includes an optical splitter 6A, a first optical modulator 21, a second optical modulator 22, and an optical combiner 7A. The optical splitter 6A is provided on the substrate 10, and splits input light into first and second input lights. The splitting ratio of the optical splitter 6A is 1:2. The optical splitter 6A of the present embodiment includes a directional coupler. The first optical modulator 21 is an optical modulator of an electro-absorption (EA) type, is provided on the substrate 10, and modulates the first light (the first input light), which has an intensity of one-third of the intensity of the input light and is output from the optical splitter 6A, according to a first binary electrical signal. The second optical modulator 22 is an optical modulator of an electro-absorption (EA) type, is provided on the substrate 10, and modulates the second light (the second input light), which has an intensity of two-thirds of the intensity of the input light and is output from the optical splitter 6A, according to a second binary electrical signal. Both the first optical modulator 21 and the second optical modulator 22 extend along the first direction D1, and are disposed side by side in a second direction D2 intersecting the first direction D1. The optical combiner 7A is provided on the substrate 10, and combines the modulated first light L1 output from the first optical modulator 21 and the modulated second light L2 output from the second optical modulator 22. The optical combiner 7A of the present embodiment includes a multi-mode interference (MMI) coupler. The first light L1 and the second light L2 may be combined, after being emitted from a modulator chip, by a lens, a prism, or the like, or may be combined after the first light L1 and the second light L2 are incident on an optical fiber.

An optical modulator of an electro-absorption type is an optical modulator that utilizes the Franz–Keldysh effect. In contrast, an optical modulator of a Mach–Zehnder type also exists. An optical modulator of a Mach–Zehnder type modulates light by changing the refractive indices of two optical paths by an electro-optic effect to generate a phase difference between the optical paths. In such a manner, the operating principle of an optical modulator of an electro-absorption type is completely different from that of an optical modulator of a Mach–Zehnder type, and the optical modulator 2A of the present embodiment performs modulation using two optical modulators of an electro-absorption type (the first optical modulator 21 and the second optical modulator 22).

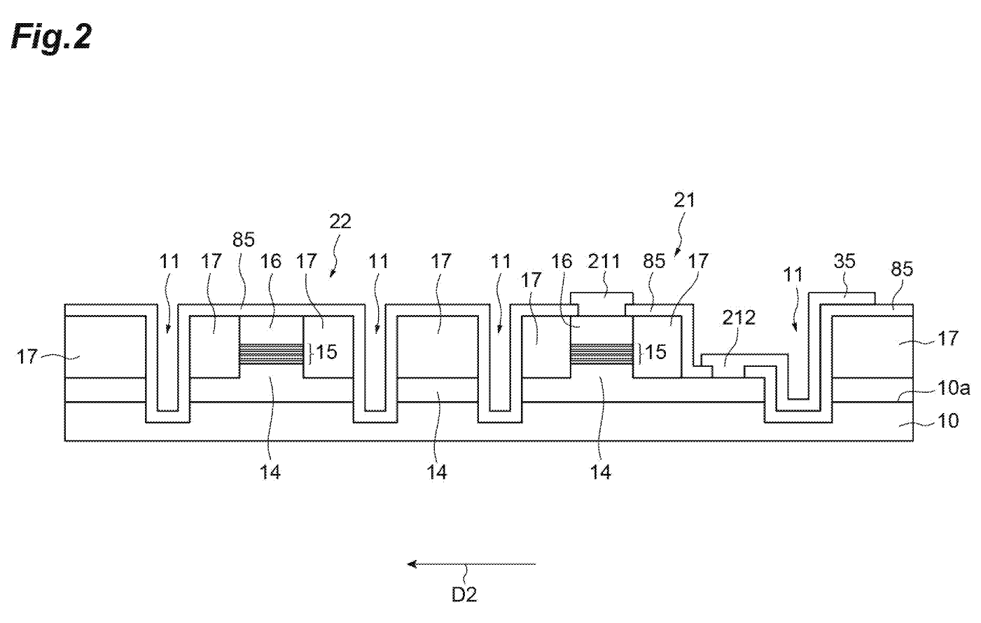

FIG. 2 is a schematic view illustrating a cross-section taken along line II-II illustrated in FIG. 1. Each of the first optical modulator 21 and the second optical modulator 22 includes a first cladding layer 14, a light absorption layer 15, and a second cladding layer 16. The first cladding layer 14, the light absorption layer 15, and the second cladding layer 16 of the present embodiment are III-V compound semiconductor layers.

The first cladding layer 14 is an n-type semiconductor layer provided on a main surface 10a of the substrate 10. In one example, the first cladding layer 14 is an n-type InP layer. The light absorption layer 15 is provided on the first cladding layer 14. The bandgap of the light absorption layer 15 is smaller than the bandgap of the first cladding layer 14. The refractive index of the light absorption layer 15 is larger than the refractive index of the first cladding layer 14. The light absorption layer 15 may have a multiple quantum well structure. In one example, the light absorption layer 15 is formed by stacking InGaAsP layers or InGaAlAs layers having different compositions. The second cladding layer 16 is provided on the light absorption layer 15, and is p-type. In one example, the second cladding layer 16 is a p-type InP layer.

A part of the first cladding layer 14, the light absorption layer 15, and the second cladding layer 16 form a mesa structure extending along the first direction D1 (the optical waveguide direction). The base of the mesa structure is located in the first cladding layer 14. Therefore, the lower portion of the first cladding layer 14 also extends outward of the mesa structure in a plan view.

The optical modulator 2A further includes an insulating film 85 and buried regions 17. The buried regions 17 are provided on both sides of the mesa structure, and bury both side surfaces of the mesa structure. The buried regions 17 have insulating properties or semi-insulating properties. The buried regions 17 are, for example, semi-insulating InP regions. The material of the buried regions 17 may be the same as the material of the substrate 10, or may be different from the material of the substrate 10. The insulating film 85 is provided on the buried regions 17, and covers the buried regions 17. The insulating film 85 is, for example, a silicon compound film such as a SiO₂ film or a SiN film.

Referring again to FIG. 1, the optical modulator 2A further includes electrode pads 31, 32, 33, 34, and 35 that are metal films. The first optical modulator 21 includes an anode electrode 211 and a cathode electrode 212. The second optical modulator 22 includes an anode electrode 221 and a cathode electrode 222. The electrode pads 31, 32, and 33 are disposed on one side with respect to the first optical modulator 21 and the second optical modulator 22, and are aligned in this order along the first direction D1 (the optical waveguide direction). The electrode pads 34 and 35 are disposed on the other side with respect to the first optical modulator 21 and the second optical modulator 22, and are aligned in this order along the first direction D1 (the optical waveguide direction).

The electrode pad 31 is connected to the first signal wiring pattern 81 by a bonding wire W1, and is connected to the electrode pad 34 by a bonding wire W2. That is, the bonding wire W2 straddles the first optical modulator 21 and the second optical modulator 22. The electrode pad 34 is connected to the anode electrode 211 of the first optical modulator 21. As illustrated in FIG. 2, the anode electrode 211 is provided on the mesa structure of the first optical modulator 21, and is connected to the second cladding layer 16 of the first optical modulator 21. The first binary electrical signal S₁ input to the first signal wiring pattern 81 is applied to the second cladding layer 16 of the first optical modulator 21 via the bonding wires W1 and W2 and the anode electrode 211.

The electrode pad 32 is connected to the cathode electrode 222 of the second optical modulator 22. The cathode electrode 222 is provided on the first cladding layer 14 on a lateral side of the mesa structure of the second optical modulator 22, and is connected to the first cladding layer 14 of the second optical modulator 22. Furthermore, the electrode pad 32 is connected to the ground wiring pattern 82 by a bonding wire W3, and is connected to the electrode pad 35 by a bonding wire W4. That is, the bonding wire W4 also straddles the first optical modulator 21 and the second optical modulator 22. The electrode pad 35 is connected to the cathode electrode 212 of the first optical modulator 21. As illustrated in FIG. 2, the cathode electrode 212 is provided on the first cladding layer 14 on a lateral side of the mesa structure of the first optical modulator 21, and is connected to the first cladding layer 14 of the first optical modulator 21. A reference potential (signal ground, indicated by “G” in FIG. 1) input to the ground wiring pattern 82 is applied to the first cladding layer 14 of the second optical modulator 22 via the bonding wire W3 and the cathode electrode 222. The reference potential input to the ground wiring pattern 82 is applied to the first cladding layer 14 of the first optical modulator 21 via the bonding wires W3 and W4 and the cathode electrode 212.

A first termination resistor 51 is provided between the electrode pad 34 and the electrode pad 35. The first termination resistor 51 connects the electrode pad 34 to the electrode pad 35. The first termination resistor 51 is provided on the substrate 10, and terminates the first binary electrical signal S₁. The first termination resistor 51 is provided at a position close to the electrode pad 34. A distance between the first termination resistor 51 and the electrode pad 34 is, for example, several tens of µm or less. Accordingly, the frequency characteristics of the first binary electrical signal S₁ are improved.

The electrode pad 33 is connected to the second signal wiring pattern 83 by a bonding wire W5. The electrode pad 33 is connected to the anode electrode 221 of the second optical modulator 22. The anode electrode 221 is provided on the mesa structure of the second optical modulator 22, and is connected to the second cladding layer 16 of the second optical modulator 22. The second binary electrical signal S₂ input to the second signal wiring pattern 83 is applied to the second cladding layer 16 of the second optical modulator 22 via the bonding wire W5 and the anode electrode 221. A second termination resistor 52 is provided between the electrode pad 33 and the electrode pad 32. The second termination resistor 52 connects the electrode pad 33 to the electrode pad 32. The second termination resistor 52 is provided on the substrate 10, and terminates the second binary electrical signal S₂. The second termination resistor 52 is provided at a position close to the electrode pad 33. A distance between the second termination resistor 52 and the electrode pad 33 is, for example, several tens of µm or less. Accordingly, the frequency characteristics of the second binary electrical signal S₂ are improved.

The resistance value of the first termination resistor 51 is determined according to the impedance of the first optical modulator 21. The resistance value of the second termination resistor 52 is determined according to the impedance of the second optical modulator 22. The splitting ratio of the optical splitter 6A is 1:2, and the impedance of the second optical modulator 22 is different from the impedance of the first optical modulator 21, and therefore, the resistance value of the second termination resistor 52 is different from the resistance value of the first termination resistor 51. The disposition of the first termination resistor 51 and the second termination resistor 52 is not limited to the present embodiment, and for example, the first termination resistor 51 and the second termination resistor 52 may be installed on the carrier 80. The first termination resistor 51 and the second termination resistor 52 may be replaced with CR circuits, each having a complex impedance.

The bonding wire W3 at the reference potential is located between the bonding wire W1 that transmits the first binary electrical signal S₁ and the bonding wire W5 that transmits the second binary electrical signal S₂. Further, the bonding wires W1, W3, and W5 extend parallel to each other. With such a configuration, the frequency characteristics of the first binary electrical signal S₁ and the second binary electrical signal S₂ are improved.

The optical modulator 2A further has a plurality of trenches (grooves) 11. As illustrated in FIG. 2, the plurality of trenches 11 reach the substrate 10 from the upper surface of the second cladding layer 16, and electrically isolate the first optical modulator 21 and the second optical modulator 22 from each other. In FIG. 1, the trenches 11 are indicated by thick lines. Specifically, the first optical modulator 21 is interposed between a pair of the trenches 11, and the second optical modulator 22 is interposed between another pair of the trenches 11. A certain spacing (for example, several µm to several tens of µm) is provided between the trench 11 on the inner side (on the side closer to the second optical modulator 22) of the pair of trenches 11 that interpose the first optical modulator 21 therebetween and the trench 11 on the inner side (on the side closer to the first optical modulator 21) of the pair of trenches 11 that interpose the second optical modulator 22 therebetween. The trench 11 on the outer side of the pair of trenches 11 that interpose the first optical modulator 21 therebetween bulges outward such that the portion of the first cladding layer 14, which is connected to the cathode electrode 212, is located between the pair of trenches 11. Similarly, the trench 11 on the outer side of the pair of trenches 11 that interpose the second optical modulator 22 therebetween bulges outward such that the portion of the first cladding layer 14, which is connected to the cathode electrode 222, is located between the pair of trenches 11. The inner surfaces of the trenches 11 are covered by the insulating film 85.

A wiring that connects the electrode pad 34 and the anode electrode 211 of the first optical modulator 21, a wiring that connects the electrode pad 35 and the cathode electrode 212 of the first optical modulator 21, a wiring that connects the electrode pad 32 and the cathode electrode 222 of the second optical modulator 22, and a wiring that connects the electrode pad 33 and the anode electrode 221 of the second optical modulator 22 are formed of metal films. These metal films extend across the trench 11 by being provided so as to run along the side walls and bottom surfaces of the trench 11.

The cross-sectional structures of the optical splitter 6A and the optical combiner 7A are the same as those of the optical modulator 2A described above, except that an anode electrode and a cathode electrode are not provided. The trenches 11 may or may not be provided in the optical splitter 6A and the optical combiner 7A.

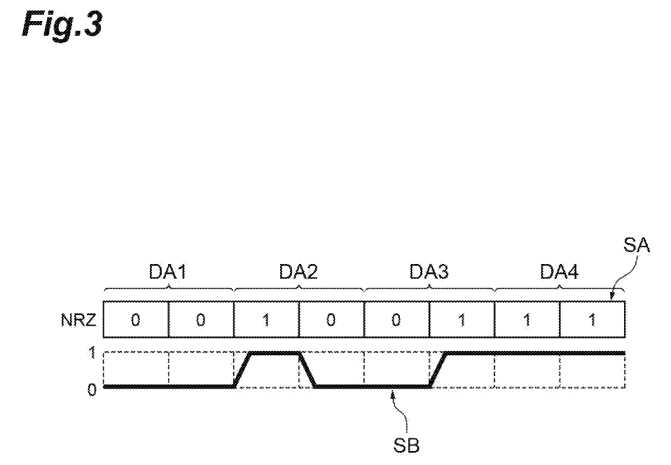

Here, the first binary electrical signal S₁ and the second binary electrical signal S₂ will be described in detail. FIG. 3 is a conceptual diagram illustrating a binary electrical signal that is used as the basis for generating the first binary electrical signal S₁ and the second binary electrical signal S₂. FIG. 3 illustrates a base binary electrical signal (an NRZ signal). A numerical sequence SA in FIG. 3 indicates the values of the binary electrical signal in a time series. A graph SB in FIG. 3 illustrates a temporal variation in the values of the binary electrical signal. In this example, four binary data DA1, DA2, DA3, and DA4 are transmitted. In this example, the values of the data DA1, DA2, DA3, and DA4 are 0, 2, 1, and 3 in a decimal notation, respectively.

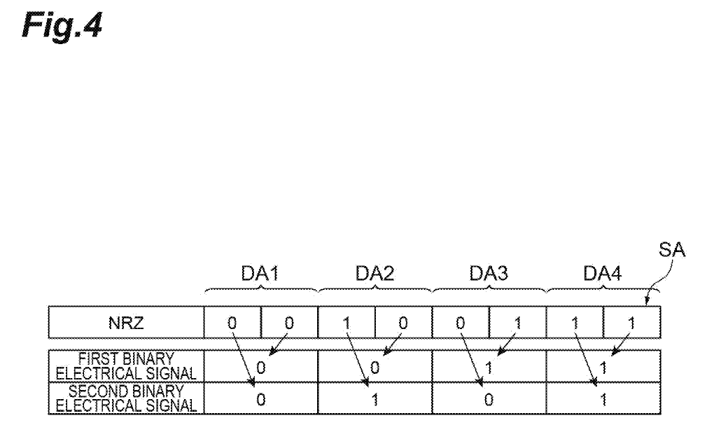

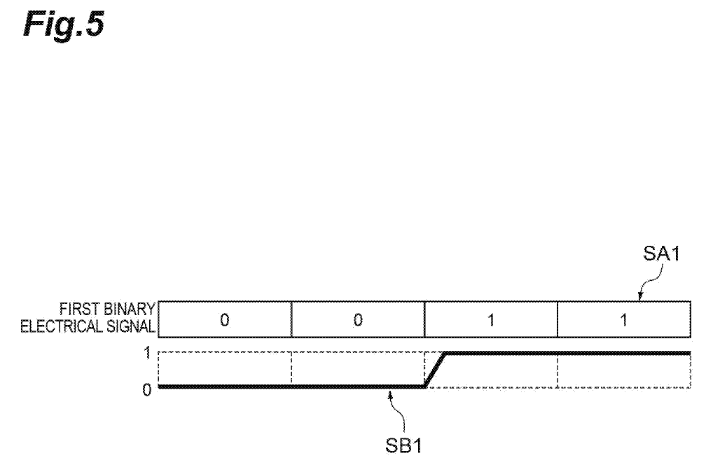

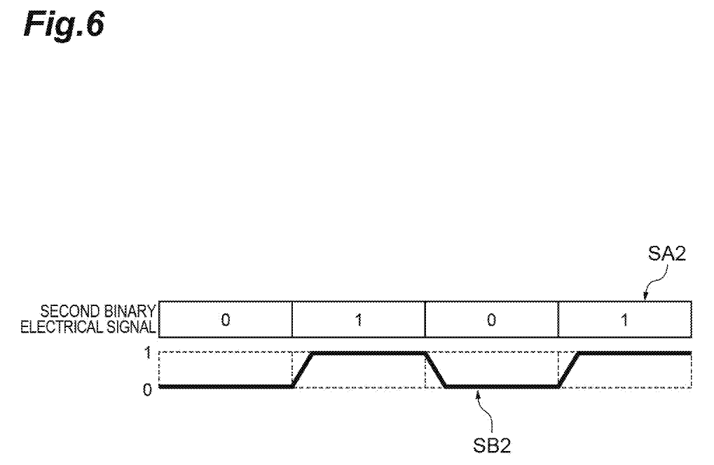

FIG. 4 is a diagram illustrating a method for converting the binary electrical signal illustrated in FIG. 3 into the first binary electrical signal S₁ and the second binary electrical signal S₂. As illustrated in FIG. 4, of the two-bit values constituting each of the data DA1, DA2, DA3, and DA4, the most significant bit value is set as the second binary electrical signal S₂, and the least significant bit value is set as the first binary electrical signal S₁. FIGS. 5 and 6 are conceptual diagrams illustrating the first binary electrical signal S₁ and the second binary electrical signal S₂. A numerical sequence SA1 in FIG. 5 indicates the values of the first binary electrical signal S₁ in a time series. A graph SB1 in FIG. 5 illustrates a temporal variation in the values of the first binary electrical signal S₁. A numerical sequence SA2 in FIG. 6 indicates the values of the second binary electrical signal S₂ in a time series. A graph SB2 in FIG. 6 illustrates a temporal variation in the values of the second binary electrical signal S₂.

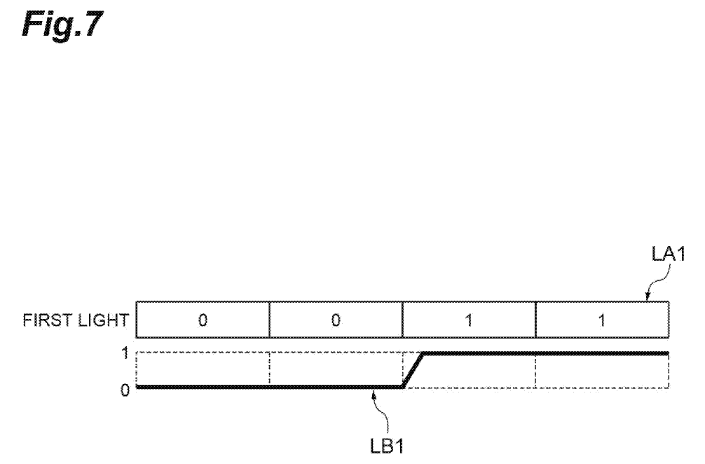

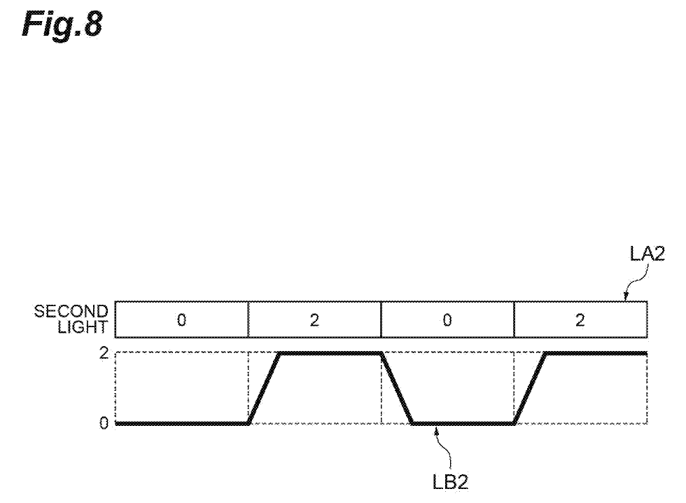

FIG. 7 is a diagram illustrating the optical power of the modulated first light L1 output from the first optical modulator 21 that receives the first binary electrical signal S₁. A numerical sequence LA1 in FIG. 7 indicates the optical power of the first light L1 in a time series. A graph LB1 in FIG. 7 illustrates a temporal variation in the optical power of the first light L1. FIG. 8 is a diagram illustrating the optical power of the modulated second light L2 output from the second optical modulator 22 that receives the second binary electrical signal S₂. A numerical sequence LA2 in FIG. 8 indicates the optical power of the second light L2 in a time series. A graph LB2 in FIG. 8 illustrates a temporal variation in the optical power of the second light L2. The numerical sequence LA1 in FIG. 7 and the numerical sequence LA2 in FIG. 8 are normalized values in which the optical power of the first light L1 in an on state is set to 1.

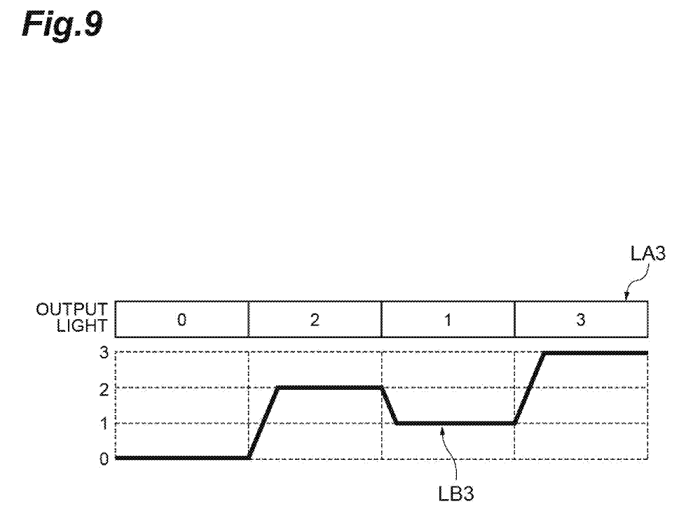

FIG. 9 is a diagram illustrating the optical power of output light Lout output from the optical combiner 7A. A numerical sequence LA3 in FIG. 9 indicates the optical power of the output light Lout in a time series. A graph LB3 in FIG. 9 illustrates a temporal variation in the optical power of the output light Lout. The modulated first light L1 having the optical power illustrated in FIG. 7 and the modulated second light L2 having the optical power illustrated in FIG. 8 are combined by the optical combiner 7A, thereby causing the output light Lout to become, as illustrated in FIG. 9, a four-level optical signal (a PAM4 signal) including the data DA1, DA2, DA3, and DA4 of the base binary electrical signal (see FIG. 3).

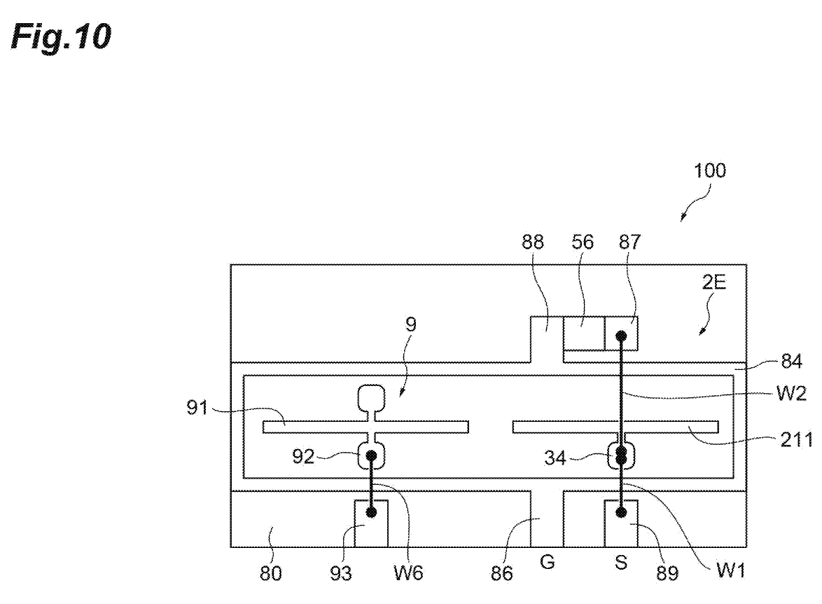

The effects obtained by the optical modulator 2A and the laser device 1A of the present embodiment described above will be described together with the problems associated with a comparative example. FIG. 10 is a plan view illustrating a laser device 100 according to a comparative example. The laser device 100 includes an optical modulator 2E and the laser emitter 9. A configuration of the laser emitter 9 is the same as that in the present embodiment. The optical modulator 2E includes a single optical modulator of an electro-absorption type. The optical modulator 2E includes the anode electrode 211 and the electrode pad 34 connected to the anode electrode 211. A modulation signal is input to the electrode pad 34 from a signal wiring pattern 89 on the carrier 80 via the bonding wire W1. The modulation signal includes a PAM4 signal. The electrode pad 34 is connected to a wiring pattern 87 on the carrier 80 by the bonding wire W2. Ground wiring patterns 86 and 88 on the carrier 80 are integrated with the ground pattern 84. The cathode electrode of the optical modulator 2E is provided on the back surface of the optical modulator 2E, and is conductively bonded to the ground pattern 84. A termination resistor 56 is provided between the wiring pattern 87 and the ground wiring pattern 88.

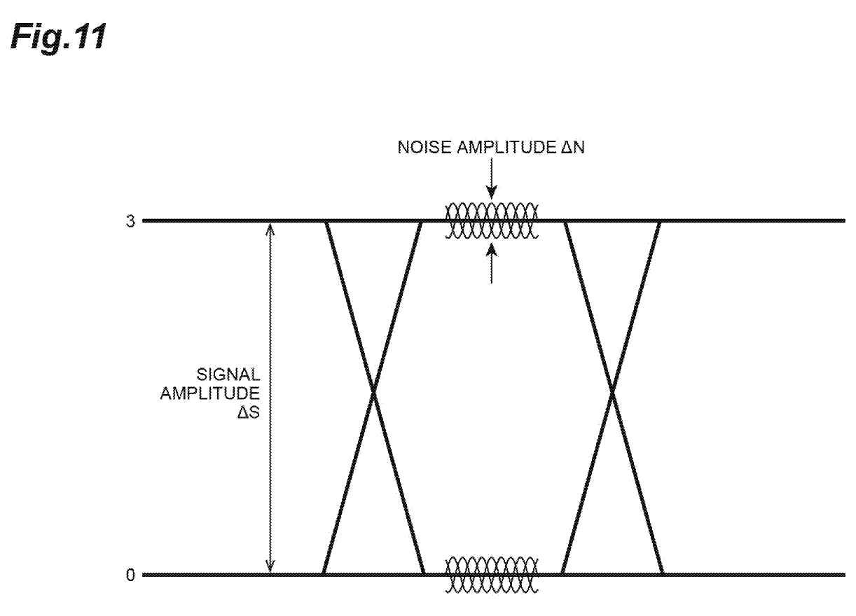

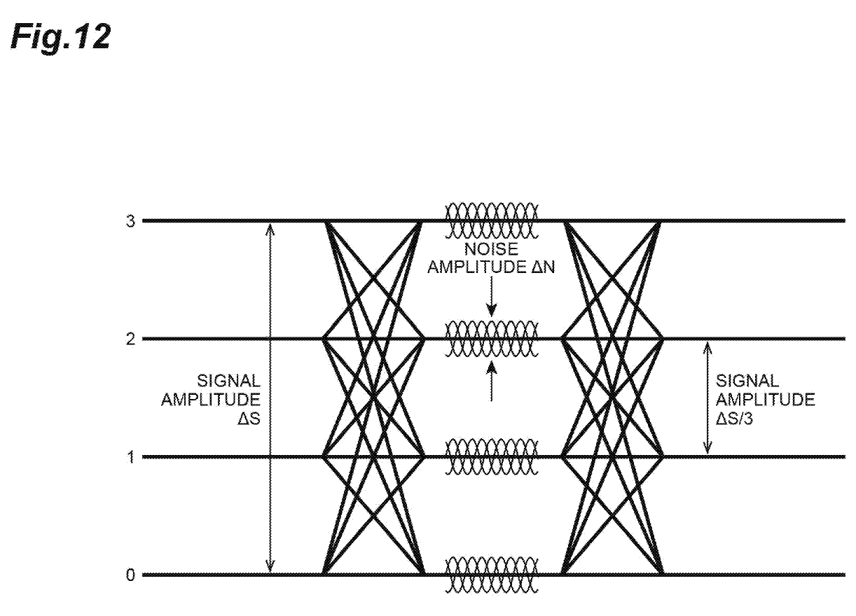

In the laser device 100 illustrated in FIG. 10, a PAM4 signal is input to the anode electrode 211 as a modulation signal. However, when PAM4 modulation is performed using such a driving method, the signal-to-noise ratio (S/N ratio) decreases since the signal amplitude becomes smaller compared to a pulse modulation method using only binary values (on/off). That is, when the S/N ratio of the modulation signal input to the optical modulator from an external circuit is taken into consideration, in the pulse modulation method using only binary values (on/off), as illustrated in FIG. 11, the S/N ratio becomes the ratio ΔS/ΔN of the amplitude ΔS of the modulation signal to the noise amplitude ΔN. In contrast, in the modulation method using a PAM4 signal as a modulation signal, as illustrated in FIG. 12, the S/N ratio becomes the ratio (ΔS/3)/ΔN of the amplitude ΔS/3 of the modulation signal to the noise amplitude ΔN. Therefore, the S/N ratio when a PAM4 signal is used as a modulation signal becomes approximately one-third of the S/N ratio when only binary values are used, thereby degrading communication quality.

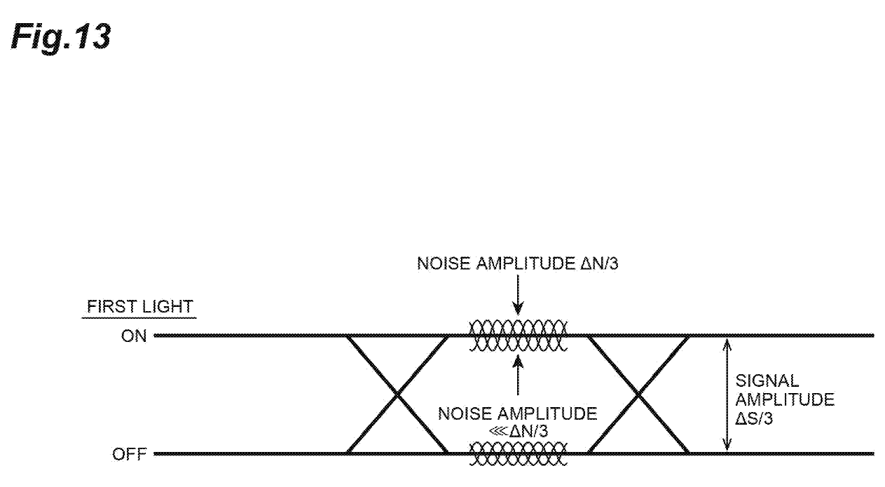

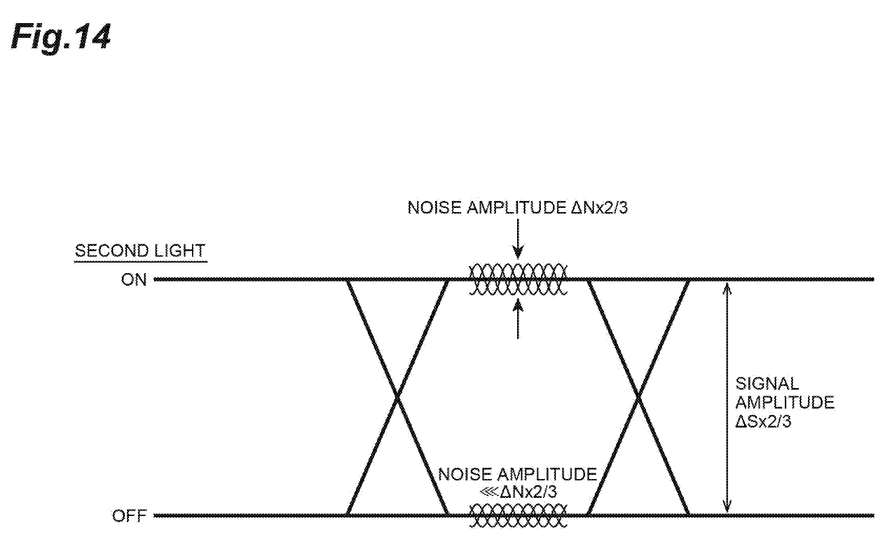

To address such a problem, in the first light L1 of the present embodiment, as illustrated in FIG. 13, since the magnitude of the modulation signal and the optical power become one-third of those of the binary method, the noise amplitude also becomes ΔN x 1/3. In addition, in the second light L2 of the present embodiment, as illustrated in FIG. 14, since the magnitude of the modulation signal and the optical power become two-thirds of those of the binary method, the noise amplitude also becomes ΔN x 2/3. Therefore, the noise amplitude of the output light Lout obtained by combining these lights becomes ΔN x 1/3 + ΔN x 2/3 = ΔN. Thus, the S/N ratio becomes ΔS/ΔN at its maximum, and it can be expected that the S/N ratio becomes equal to or greater than the S/N ratio of the binary method. The noise amplitude of the first light L1 in an off state is sufficiently smaller than ΔN × 1/3 due to the extinction characteristics of the first optical modulator 21. Similarly, the noise amplitude of the second light L2 in an off state is sufficiently smaller than ΔN × 2/3 due to the extinction characteristics of the second optical modulator 22. Thus, the S/N ratio after optical combination is improved compared to the conventional method, and an effect of improving communication quality is obtained.

The present embodiment illustrates a case where the output light Lout is modulated by PAM4; however, the concept of the present embodiment is also effective for multilevel pulse amplitude modulation other than PAM4, such as PAM8 or PAM16. That is, the configuration of the optical modulator of the present embodiment can be restated as follows by expanding the concept to multilevel pulse amplitude modulation of four or more levels. The optical modulator includes an optical splitter that splits input light into first to N-th lights (where N is an integer of two or more); first to N-th optical modulators of an electro-absorption type that modulate, by binary electrical signals, the first to N-th lights output from the optical splitter, respectively; and an optical combiner that combines the first to N-th lights output from the first to N-th optical modulators. An optical power of the n-th light may be 2^{(n - 1)} times an optical power of the first light, n being 2, ..., N. First to N-th binary electrical signals obtained by decomposing a binary electrical signal are provided to the first to N-th optical modulators, respectively, such that output light from the optical combiner includes a multilevel optical signal.

As in the present embodiment, the optical modulator 2A may include the substrate 10 that is one of a semi-insulating type, an insulating type, p-type, or n-type substrate. Further, the optical splitter 6A, the first optical modulator 21, the second optical modulator 22, and the optical combiner 7A may be provided on the substrate 10. In this case, the optical modulator 2A can be made more compact compared to a case where the optical splitter 6A, the first optical modulator 21, the second optical modulator 22, and the optical combiner 7A are provided as individual elements.

As in the present embodiment, one of the optical splitter 6A and the optical combiner 7A may include a directional coupler. Alternatively, both the optical splitter 6A and the optical combiner 7A may include directional couplers. In that case, light can be split or combined with a simple structure on the substrate 10.

As in the present embodiment, one of the optical splitter 6A and the optical combiner 7A may include an MMI coupler. Alternatively, both the optical splitter 6A and the optical combiner 7A may include MMI couplers. In that case, light can be split or combined with a simple structure on the substrate 10.

The laser device 1A of the present embodiment includes the laser emitter 9 that is provided on the substrate 10 common to the optical modulator 2A, and that outputs laser light. Further, the input light of the optical splitter 6A is the laser light from the laser emitter 9. According to the laser device 1A, the quality of the optical signal can be improved by including the optical modulator 2A.

### First modification example

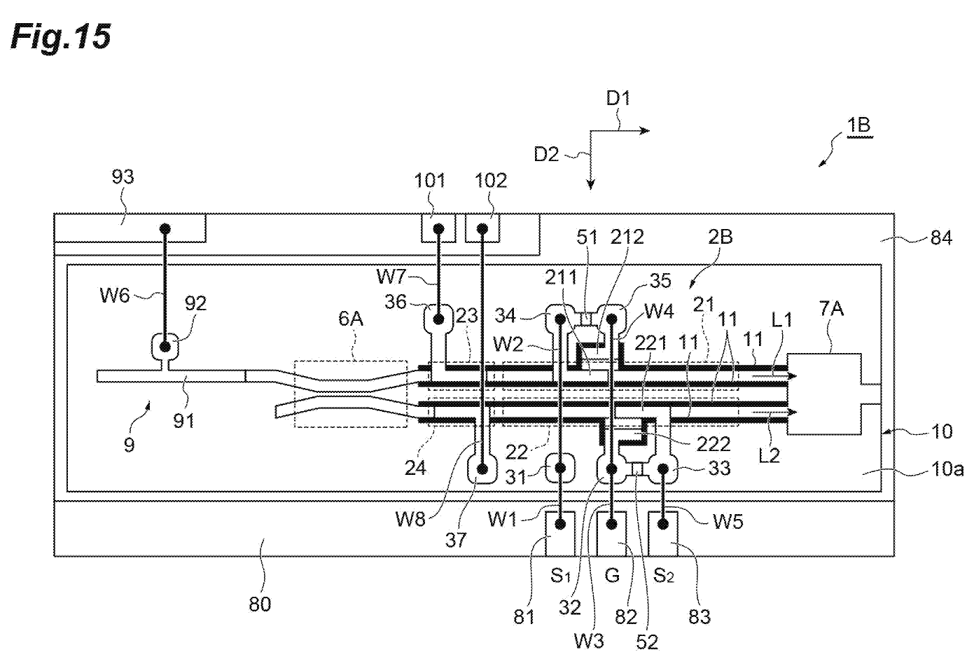

FIG. 15 is a plan view illustrating a laser device 1B according to a first modification example. The laser device 1B according to the present modification example differs from the laser device 1A of the above-described embodiment in the following points, and is identical to the laser device 1A of the above-described embodiment in other points.

The laser device 1B includes an optical modulator 2B instead of the optical modulator 2A of the above-described embodiment. The optical modulator 2B further includes optical modulators 23 and 24 in addition to the configuration of the optical modulator 2A of the above-described embodiment. The optical modulator 23 is provided between the optical splitter 6A and the first optical modulator 21 or is provided between the first optical modulator 21 and the optical combiner 7A, and adjusts the optical power of the first light. The optical modulator 24 is provided between the optical splitter 6A and the second optical modulator 22 or is provided between the second optical modulator 22 and the optical combiner 7A, and adjusts the optical power of the second light. The structures of the optical modulators 23 and 24 are the same as those of the first optical modulator 21 and the second optical modulator 22, except that the optical modulators 23 and 24 do not include cathode electrodes.

The optical modulator 2B further includes electrode pads 36 and 37 provided on the substrate 10. The electrode pad 36 is connected to the anode electrode of the optical modulator 23. The electrode pad 37 is connected to the anode electrode of the optical modulator 24. Optical power adjustment wiring patterns 101 and 102 are provided on the carrier 80. The electrode pad 36 is connected to the optical power adjustment wiring pattern 101 by a bonding wire W7. An optical power adjustment voltage is applied to the anode electrode of the optical modulator 23 from the optical power adjustment wiring pattern 101 via the bonding wire W7 and the electrode pad 36. The electrode pad 37 is connected to the optical power adjustment wiring pattern 102 by a bonding wire W8. An optical power adjustment voltage is applied to the anode electrode of the optical modulator 24 from the optical power adjustment wiring pattern 102 via the bonding wire W8 and the electrode pad 37.

As in the present modification example, the optical modulators 23 and 24 for optical power adjustment may be provided between the optical splitter 6A and each of the first optical modulator 21 and the second optical modulator 22, or between each of the first optical modulator 21 and the second optical modulator 22 and the optical combiner 7A. In this case, the ratio of the optical power of the first light L1 to the optical power of the second light L2 can be made close to 1:2 with high accuracy. In the configuration in which the optical splitter splits input light into first to N-th lights (where N is an integer of two or more), the first to N-th optical modulators modulate the first to N-th lights, respectively, and the optical combiner combines the modulated first to N-th lights, the optical modulators for optical power adjustment are provided between the optical splitter and each of the first to N-th optical modulators, or between each of the first to N-th optical modulators and the optical combiner.

### Second modification example

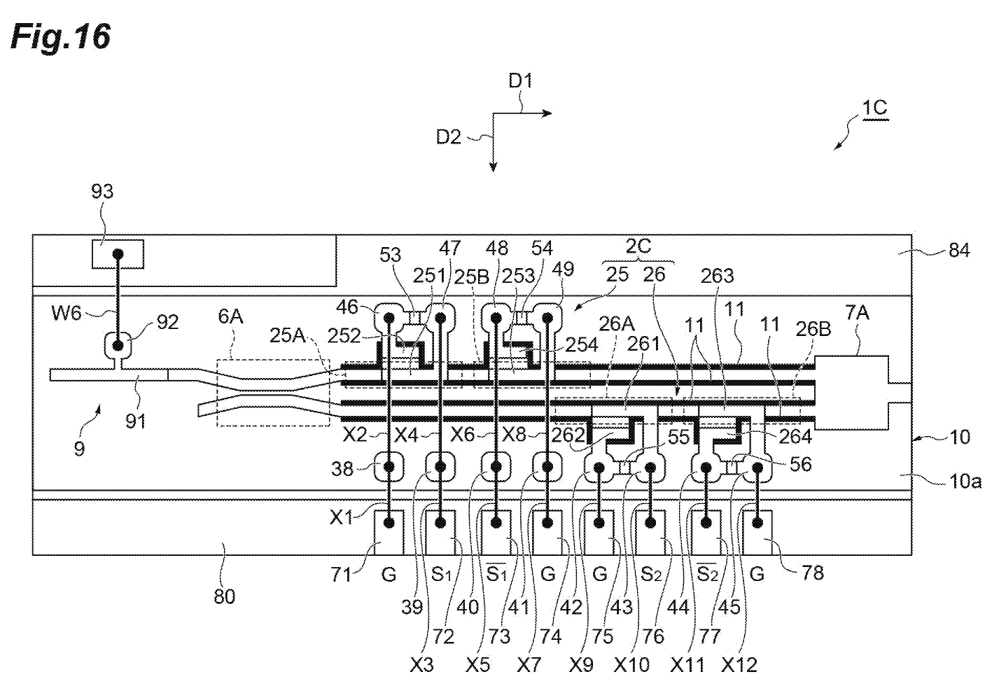

FIG. 16 is a plan view illustrating a laser device 1C according to a second modification example. The laser device 1C according to the present modification example differs from the laser device 1A of the above-described embodiment in the following points, and is identical to the laser device 1A of the above-described embodiment in other points. The laser device 1C includes an optical modulator 2C instead of the optical modulator 2A of the above-described embodiment. The optical modulator 2C includes the optical splitter 6A, a first optical modulator 25, a second optical modulator 26, and the optical combiner 7A. Among these sections, the configurations of the optical splitter 6A and the optical combiner 7A are the same as those in the above-described embodiment.

The first optical modulator 25 is an optical modulator of an EA type, is provided on the substrate 10, and modulates the first light, which is output from the optical splitter 6A, according to a first binary electrical signal, which is a differential signal. The second optical modulator 26 is an optical modulator of an EA type, is provided on the substrate 10, and modulates the second light, which is output from the optical splitter 6A, according to a second binary electrical signal, which is a differential signal. The optical combiner 7A combines the modulated first light output from the first optical modulator 25 and the modulated second light output from the second optical modulator 26. Details of the first binary electrical signal and the second binary electrical signal are the same as those in the above-described embodiment, except that the first binary electrical signal and the second binary electrical signal are differential signals.

Both the first optical modulator 25 and the second optical modulator 26 extend along the first direction D1, and are disposed side by side in a direction intersecting the first direction D1. The first optical modulator 25 includes an optical modulator 25A and an optical modulator 25B. The optical modulator 25A and the optical modulator 25B are provided side by side in the optical waveguide direction of the first light. The second optical modulator 26 includes an optical modulator 26A and an optical modulator 26B. The optical modulator 26A and the optical modulator 26B are provided side by side in the optical waveguide direction of the second light.

The optical modulator 25A includes an anode electrode 251 and a cathode electrode 252. The optical modulator 25B includes an anode electrode 253 and a cathode electrode 254. The anode electrodes 251 and 253 correspond to the anode electrode 211 of the above-described embodiment. The cathode electrodes 252 and 254 correspond to the cathode electrode 212 of the above-described embodiment. The internal structure of the optical modulators 25A and 25B is the same as the internal structure of the first optical modulator 21 of the above-described embodiment. The optical modulator 26A includes an anode electrode 261 and a cathode electrode 262. The optical modulator 26B includes an anode electrode 263 and a cathode electrode 264. The anode electrodes 261 and 263 correspond to the anode electrode 221 of the above-described embodiment. The cathode electrodes 262 and 264 correspond to the cathode electrode 222 of the above-described embodiment. The internal structure of the optical modulators 26A and 26B is the same as the internal structure of the second optical modulator 22 of the above-described embodiment.

The optical modulator 2C includes electrode pads 38, 39, 40, 41, 42, 43, 44, 45, 46, 47, 48, and 49 instead of the electrode pads 31 to 35 of the above-described embodiment. The electrode pads 38 to 45 are disposed on one side with respect to the first optical modulator 25 and the second optical modulator 26, and are aligned in this order along the first direction D1 (the optical waveguide direction). The electrode pads 46 to 49 are disposed on the other side with respect to the first optical modulator 25 and the second optical modulator 26, and are aligned in this order along the first direction D1 (the optical waveguide direction). Instead of the first signal wiring pattern 81, the ground wiring pattern 82, and the second signal wiring pattern 83 of the above-described embodiment, ground wiring patterns 71, 74, 75, and 78, first signal wiring patterns 72 and 73, and second signal wiring patterns 76 and 77 are provided on the main surface of the carrier 80.

The electrode pad 38 is connected to the ground wiring pattern 71 by a bonding wire X1, and is connected to the electrode pad 46 by a bonding wire X2. The electrode pad 46 is connected to the cathode electrode 252 of the optical modulator 25A. A reference potential input to the ground wiring pattern 71 is applied to the first cladding layer 14 of the optical modulator 25A via the bonding wires X1 and X2 and the cathode electrode 252. The electrode pad 39 is connected to the first signal wiring pattern 72 by a bonding wire X3, and is connected to the electrode pad 47 by a bonding wire X4. The electrode pad 47 is connected to the anode electrode 251 of the optical modulator 25A. The positive-phase signal of the first binary electrical signal S₁ input to the first signal wiring pattern 72 is applied to the second cladding layer 16 of the optical modulator 25A via the bonding wires X3 and X4 and the anode electrode 251.

The electrode pad 40 is connected to the first signal wiring pattern 73 by a bonding wire X5, and is connected to the electrode pad 48 by a bonding wire X6. The electrode pad 48 is connected to the cathode electrode 254 of the optical modulator 25B. The inverted-phase signal of the first binary electrical signal S₁ input to the first signal wiring pattern 73 is applied to the first cladding layer 14 of the optical modulator 25B via the bonding wires X5 and X6 and the cathode electrode 254. The electrode pad 41 is connected to the ground wiring pattern 74 by a bonding wire X7, and is connected to the electrode pad 49 by a bonding wire X8. The electrode pad 49 is connected to the anode electrode 253 of the optical modulator 25B. The reference potential input to the ground wiring pattern 74 is applied to the second cladding layer 16 of the optical modulator 25B via the bonding wires X7 and X8 and the anode electrode 253.

The electrode pad 42 is connected to the ground wiring pattern 75 by a bonding wire X9, and is connected to the cathode electrode 262 of the optical modulator 26A. The reference potential input to the ground wiring pattern 75 is applied to the first cladding layer 14 of the optical modulator 26A via the bonding wire X9 and the cathode electrode 262. The electrode pad 43 is connected to the second signal wiring pattern 76 by a bonding wire X10. The electrode pad 43 is connected to the anode electrode 261 of the optical modulator 26A. The positive-phase signal of the second binary electrical signal S₂ input to the second signal wiring pattern 76 is applied to the second cladding layer 16 of the optical modulator 26A via the bonding wire X10 and the anode electrode 261.

The electrode pad 44 is connected to the second signal wiring pattern 77 by a bonding wire X11, and is connected to the cathode electrode 264 of the optical modulator 26B. The inverted-phase signal of the second binary electrical signal S₂ input to the second signal wiring pattern 77 is applied to the first cladding layer 14 of the optical modulator 26B via the bonding wire X11 and the cathode electrode 264. The electrode pad 45 is connected to the ground wiring pattern 78 by a bonding wire X12, and is connected to the anode electrode 263 of the optical modulator 26B. The reference potential input to the ground wiring pattern 78 is applied to the second cladding layer 16 of the optical modulator 26B via the bonding wire X12 and the anode electrode 263.

A termination resistor 53 is provided between the electrode pad 46 and the electrode pad 47. The termination resistor 53 connects the electrode pad 47 to the electrode pad 46. The termination resistor 53 is provided on the substrate 10, and terminates the positive-phase signal of the first binary electrical signal S₁. A termination resistor 54 is provided between the electrode pad 48 and the electrode pad 49. The termination resistor 54 connects the electrode pad 48 to the electrode pad 49. The termination resistor 54 is provided on the substrate 10, and terminates the inverted-phase signal of the first binary electrical signal S₁.

A termination resistor 55 is provided between the electrode pad 42 and the electrode pad 43. The termination resistor 55 connects the electrode pad 43 to the electrode pad 42. The termination resistor 55 is provided on the substrate 10, and terminates the positive-phase signal of the second binary electrical signal S₂. A termination resistor 56 is provided between the electrode pad 44 and the electrode pad 45. The termination resistor 56 connects the electrode pad 44 to the electrode pad 45. The termination resistor 56 is provided on the substrate 10, and terminates the inverted-phase signal of the second binary electrical signal S₂.

According to the present modification example, similarly to the above-described embodiment, multilevel pulse amplitude modulation can be performed while suppressing a decrease in the S/N ratio. As in the present modification example, the first optical modulator 25 and the second optical modulator 26 may be configured to receive differential signals and to modulate the first light and the second light, respectively. Accordingly, electrical interference between the first optical modulator 25 and the second optical modulator 26 can be reduced, and degradation of signal quality due to common-mode noise can be reduced. Therefore, the quality of the optical signal output from the optical modulator 2C can be improved. In the configuration in which the optical splitter splits input light into first to N-th lights (where N is an integer of two or more), the first to N-th optical modulators modulate the first to N-th lights, respectively, and the optical combiner combines the modulated first to N-th lights, the first to N-th optical modulators may be configured to receive differential signals and to modulate the first to N-th lights, respectively.

In a mesa structure located between the optical modulator 25A and the optical modulator 25B of the first optical modulator 25 and a mesa structure located between the optical modulator 26A and the optical modulator 26B of the second optical modulator 26, the second cladding layers 16 may be removed or thinned by etching or the like. Accordingly, the isolation resistance between the optical modulator 25A and the optical modulator 25B and the isolation resistance between the optical modulator 26A and the optical modulator 26B can be increased to, for example, several tens of Ω or more.

### Third modification example

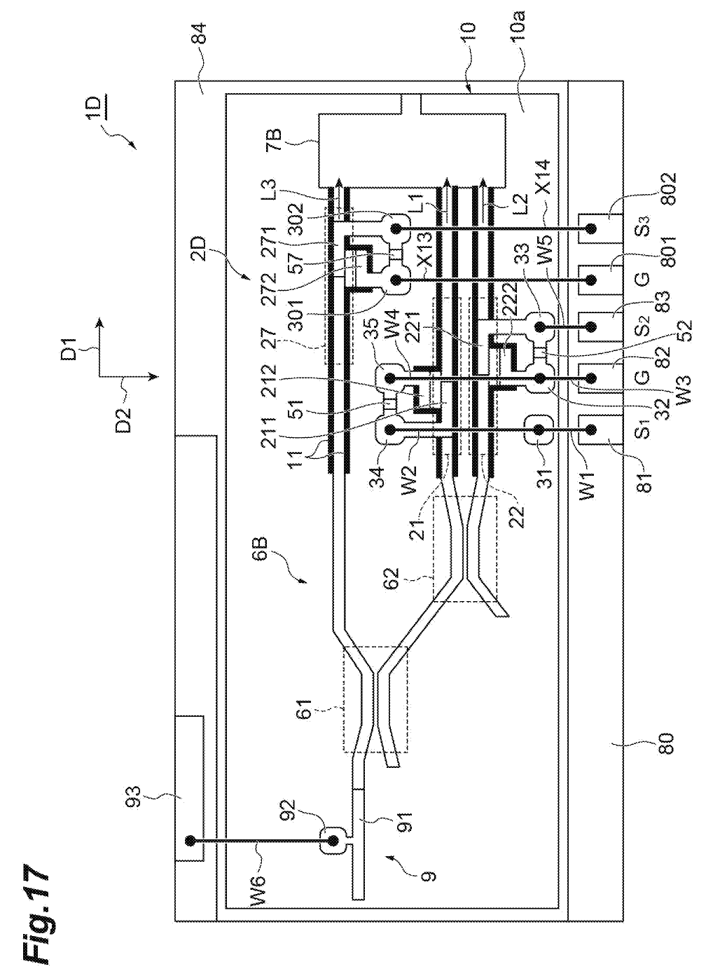

FIG. 17 is a plan view illustrating a laser device 1D according to a third modification example. The laser device 1D according to the present modification example differs from the laser device 1A of the above-described embodiment in the following points, and is identical to the laser device 1A of the above-described embodiment in other points. The laser device 1D includes an optical modulator 2D instead of the optical modulator 2A of the above-described embodiment. The optical modulator 2D includes an optical splitter 6B, the first optical modulator 21, the second optical modulator 22, a third optical modulator 27, and an optical combiner 7B. Among these sections, the configurations of the first optical modulator 21 and the second optical modulator 22 are the same as those in the above-described embodiment.

The optical splitter 6B is provided on the substrate 10, and splits input light into three lights. The splitting ratio of the optical splitter 6B is 1:2:4. Specifically, the optical splitter 6B includes a first optical splitter 61 and a second optical splitter 62. The first optical splitter 61 splits the input light from the laser emitter 9 at a splitting ratio of 4:3. The light having an intensity of four-sevenths of the intensity of the input light and output from the first optical splitter 61 (third input light) is input to the third optical modulator 27. The light having an intensity of three-sevenths of the intensity of the input light and output from the first optical splitter 61 is input to the second optical splitter 62, and is split again by the second optical splitter 62. The splitting ratio of the second optical splitter 62 is 1:2. The light having an intensity of one-seventh of the intensity of the input light and output from the second optical splitter 62 (first input light) is input to the first optical modulator 21. The light having an intensity of two-sevenths of the intensity of the input light and output from the second optical splitter 62 (second input light) is input to the second optical modulator 22.

The third optical modulator 27 is an optical modulator of an EA type, is provided on the substrate 10, and modulates a third light, which is output from the optical splitter 6B, according to a third binary electrical signal. The optical combiner 7B combines the modulated first light L1 output from the first optical modulator 21, the modulated second light L2 output from the second optical modulator 22, and the modulated third light L3 output from the third optical modulator 27. The third optical modulator 27 extends along the first direction D1, and is disposed side by side with the first optical modulator 21 and the second optical modulator 22 in a direction intersecting the first direction D1.

The optical modulator 2D further includes electrode pads 301 and 302 in addition to the electrode pads 31 to 35 of the above-described embodiment. The electrode pads 301 and 302 are disposed on one side with respect to the third optical modulator 27, and are aligned in this order along the first direction D1 (the optical waveguide direction). In addition to the first signal wiring pattern 81, the ground wiring pattern 82, and the second signal wiring pattern 83, a ground wiring pattern 801 and a third signal wiring pattern 802 are provided on the main surface of the carrier 80.

The third optical modulator 27 includes an anode electrode 271 and a cathode electrode 272. The internal structure of the third optical modulator 27 is the same as the internal structure of the first optical modulator 21 and the second optical modulator 22. The electrode pad 301 is connected to the ground wiring pattern 801 by a bonding wire X13, and is connected to the cathode electrode 272. The electrode pad 302 is connected to the third signal wiring pattern 802 by a bonding wire X14, and is connected to the anode electrode 271.

A termination resistor 57 is provided between the electrode pad 301 and the electrode pad 302. The termination resistor 57 connects the electrode pad 302 to the electrode pad 301. The termination resistor 57 is provided on the substrate 10, and terminates the third binary electrical signal S₃.

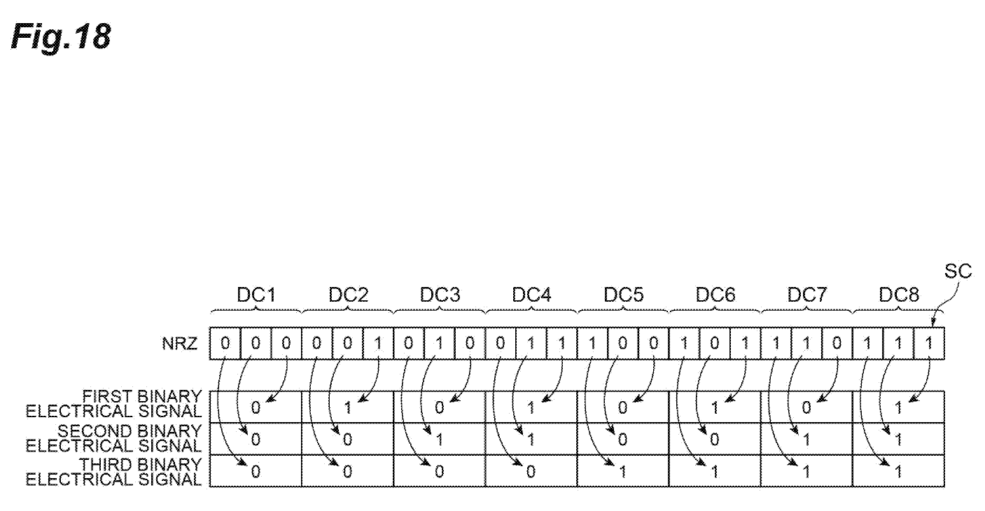

Here, the first binary electrical signal S₁, the second binary electrical signal S₂, and the third binary electrical signal S₃ will be described in detail. FIG. 18 is a diagram illustrating a method for converting a binary electrical signal into the first binary electrical signal S₁, the second binary electrical signal S₂, and the third binary electrical signal S₃. A numerical sequence SC in FIG. 18 illustrates a binary electrical signal (an NRZ signal) that is used as the basis for generating the first binary electrical signal S₁, the second binary electrical signal S₂, and the third binary electrical signal S₃. In this example, eight binary data DC1, DC2, DC3, DC4, DC5, DC6, DC7, and DC8 are transmitted. In this example, the values of the data DC1 to DC8 are 0, 1, 2, 3, 4, 5, 6, and 7 in a decimal notation, respectively.

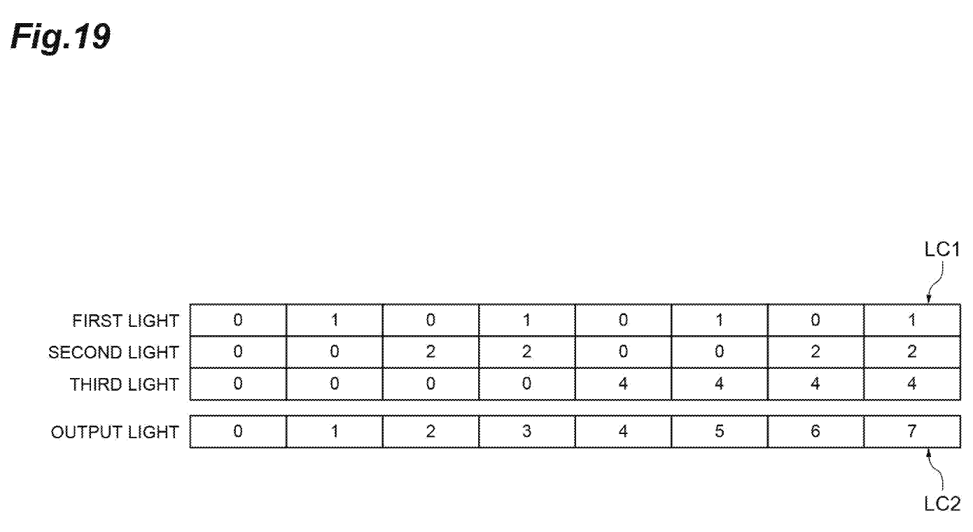

As illustrated in FIG. 18, of the three-bit values constituting each of the data DC1 to DC8, the most significant bit value is set as the third binary electrical signal S₃, the middle bit value is set as the second binary electrical signal S₂, and the least significant bit value is set as the first binary electrical signal S₁. As a result, the optical power of the modulated first light L1 output from the first optical modulator 21, the optical power of the modulated second light L2 output from the second optical modulator 22, and the optical power of the modulated third light L3 output from the third optical modulator 27 are as follows. A table indicated by LC1 in FIG. 19 shows the optical power of the modulated first light L1, the modulated second light L2, and the modulated third light L3 in a time series. The table LC1 in FIG. 19 consists of normalized values in which the optical power of the first light L1 in an on state is set to 1. The modulated first light L1, the modulated second light L2, and the modulated third light L3, having their respective optical powers as indicated in the table LC1, are combined by the optical combiner 7B, thereby causing the output light Lout to become, as indicated in a numerical sequence LC2 of FIG. 19, an eight-level optical signal (a PAM8 signal) including the data DC1 to DC8 of the base binary electrical signal (see FIG. 18).

According to the optical modulator 2D of the present modification example described above, a PAM8 signal can be generated while suppressing a decrease in the S/N ratio.

The optical modulator and the optical modulator–integrated laser device according to the present disclosure are not limited to the embodiment and each modification example described above, and can be modified in other various forms. For example, the embodiment and each modification example described above may be combined with each other in any combination. Only the optical modulator, excluding the laser emitter, may be provided on the substrate. In the embodiment and the modification examples, an optical modulator of an InP-based electro-absorption (EA) type has been illustrated as an example of the optical modulator; however, a Si-based optical modulator (silicon photonics) can also be applied.

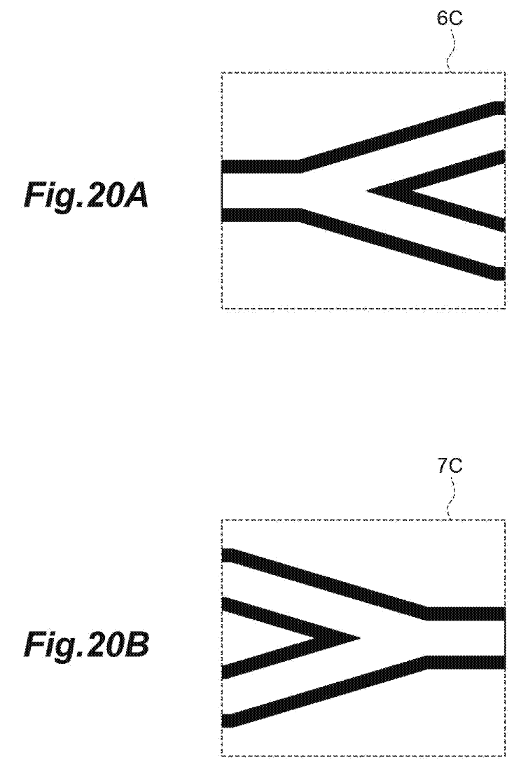

In the embodiment and each modification example described above, a directional coupler has been illustrated as an example of the optical splitter, and an MMI coupler has been illustrated as an example of the optical combiner. The configurations of the optical splitter and the optical combiner are not limited thereto, and the optical splitter may be, for example, an optical splitter 6C including a Y-shaped optical waveguide illustrated in FIG. 20A. The optical combiner may be, for example, an optical combiner 7C including a Y-shaped optical waveguide illustrated in FIG. 20B. In these cases, light can be split or combined with a simple structure on the substrate 10.

Furthermore, although not illustrated, the optical splitter may be a prism or the like, and the laser light split by the prism may be input to the optical modulator by lens coupling or the like. The optical combiner may combine the lights using a lens, a prism, or the like, or may combine the lights after the lights enter an optical fiber.

In the embodiment and each modification example described above, a case where the first cladding layer 14 is n-type and the second cladding layer 16 is p-type has been illustrated as an example; however, the first cladding layer 14 may be p-type, and the second cladding layer 16 may be n-type.

In the embodiment and each modification example described above, an InP-based semiconductor has been illustrated as an example of the III-V compound semiconductor, which is the constituent material of the first cladding layer 14, the light absorption layer 15, and the second cladding layer 16; however, the III-V compound semiconductor is not limited thereto. The materials constituting the first cladding layer 14, the light absorption layer 15, and the second cladding layer 16 may be Si-based semiconductors. In the embodiment and each modification example described above, a silicon compound film such as a SiO₂ film or a SiN film has been illustrated as an example of the constituent material of the insulating film 85; however, the constituent material (composition) of the insulating film 85 is not limited thereto. For example, the constituent material of the insulating film 85 may be silicon oxide or silicon nitride having a composition other than that in the embodiment and each modification example, or may be silicon oxynitride (SiON).

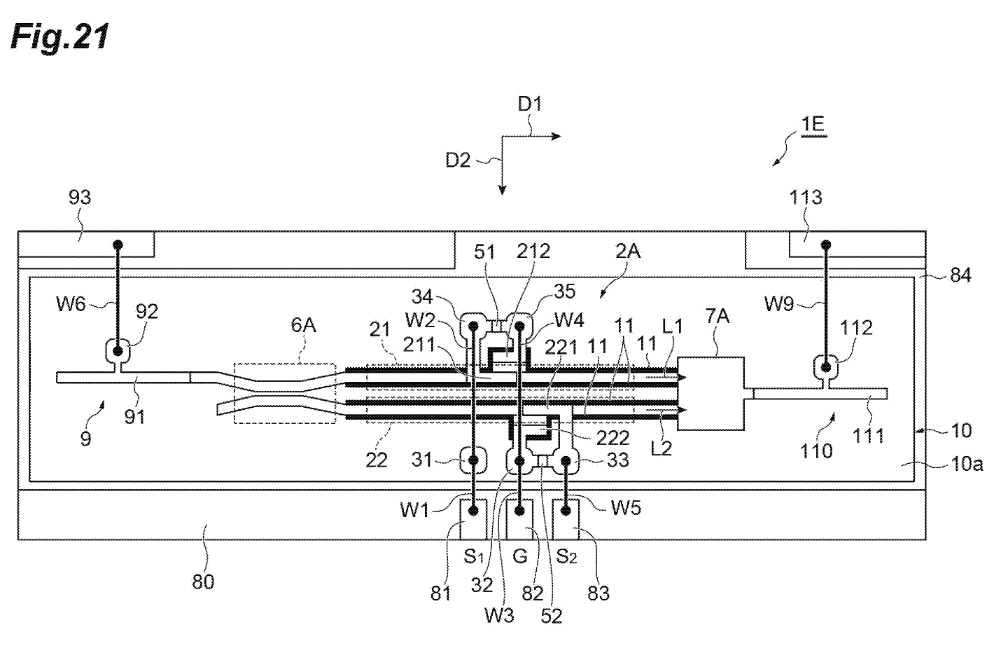

In the embodiment and each modification example described above, the optical modulator–integrated laser device may further include a semiconductor optical amplifier provided on the substrate 10. FIG. 21 is a plan view illustrating a laser device 1E including a semiconductor optical amplifier. The laser device 1E further includes a semiconductor optical amplifier 110 in addition to the configuration of the laser device 1A of the above-described embodiment. The semiconductor optical amplifier 110 is disposed on the light emission end side of the optical modulator 2A, receives, from the optical combiner 7A, the first light L1 and the second light L2 that are combined, and amplifies and outputs the first light L1 and the second light L2 that are combined.

The semiconductor optical amplifier 110 includes an electrode 111 and an electrode pad 112. The electrode 111 is an electrode for supplying a bias current to an active layer (not illustrated) of the semiconductor optical amplifier 110. The electrode 111 extends along the first direction D1 (the optical waveguide direction). The electrode pad 112 is disposed on a lateral side of the electrode 111, and is connected to the electrode 111. The electrode pad 112 is connected to a bias pattern 113 on the carrier 80 by a bonding wire W9. A bias current is supplied from the bias pattern 113 to the electrode 111 via the bonding wire W9 and the electrode pad 112.

In such a manner, the optical modulator–integrated laser device may further include the semiconductor optical amplifier 110 provided on the substrate 10. Accordingly, compared to a case where the semiconductor optical amplifier is provided external to the substrate 10, the device including the optical modulator–integrated laser device can be made more compact.

What is claimed is:

1. An optical modulator comprising:
a first optical modulator and a second optical modulator of an electro-absorption type configured to modulate a first input light and a second input light, respectively, which are obtained by splitting an optical power of light at a splitting ratio of 1:2,
wherein a signal ground is connected to a cathode electrode of each of the first optical modulator and the second optical modulator,
a first binary electrical signal and a second binary electrical signal obtained by decomposing a binary electrical signal are applied to an anode electrode of the first optical modulator and an anode electrode of the second optical modulator, respectively, and
a first binary optical signal and a second binary optical signal output from the first optical modulator and the second optical modulator, respectively, are combined with each other to form a four-level optical signal.

2. An optical modulator comprising:
a first optical modulator, a second optical modulator, and a third optical modulator of an electro-absorption type configured to modulate a first input light, a second input light, and a third input light, respectively, which are obtained by splitting an optical power of light at a splitting ratio of 1:2:4,
wherein a signal ground is connected to a cathode electrode of each of the first optical modulator, the second optical modulator, and the third optical modulator,
a first binary electrical signal, a second binary electrical signal, and a third binary electrical signal obtained by decomposing a binary electrical signal are applied to anode electrodes of the first optical modulator, the second optical modulator, and the third optical modulator, respectively, and
a first binary optical signal, a second binary optical signal, and a third binary optical signal output from the first optical modulator, the second optical modulator, and the third optical modulator, respectively, are combined with each other to form an eight-level optical signal.

3. The optical modulator according to claim 1, further comprising:
an optical splitter configured to split the light;
an optical combiner configured to combine the light; and
an optical modulator for optical power adjustment provided between the optical splitter and the optical combiner.

4. The optical modulator according to claim 1,
wherein the first optical modulator and the second optical modulator are configured to receive differential signals as the first binary electrical signal and the second binary electrical signal, and to modulate the first input light and the second input light, respectively.

5. The optical modulator according to claim 2,
wherein the first optical modulator, the second optical modulator, and the third optical modulator are configured to receive differential signals as the first binary electrical signal, the second binary electrical signal, and the third binary electrical signal, and to modulate the first input light, the second input light, and the third input light, respectively.

6. The optical modulator according to claim 1, further comprising:
a substrate that is one of a semi-insulating type, an insulating type, a p-type, or an n-type,
wherein the first optical modulator and the second optical modulator are provided on the substrate.

7. The optical modulator according to claim 2, further comprising:
a substrate that is one of a semi-insulating type, an insulating type, a p-type, or an n-type,
wherein the first optical modulator, the second optical modulator, and the third optical modulator are provided on the substrate.

8. The optical modulator according to claim 3,
wherein one or both of the optical splitter and the optical combiner includes one of a Y-shaped optical waveguide, a directional coupler, or a multi-mode interference coupler.

9. The optical modulator according to claim 1,
wherein each of the first optical modulator and the second optical modulator is formed of a semiconductor layer including a light absorption layer, and a material of the semiconductor layer is an InP-based material or an Si-based material.

10. An optical modulator–integrated laser device comprising:
the optical modulator according to claim 3 that is provided on a substrate; and
a laser emitter that is provided on the substrate, is formed of a semiconductor layer including an active layer, and outputs laser light,
wherein the input light of the optical splitter is the laser light.

11. The optical modulator–integrated laser device according to claim 10, further comprising:
a semiconductor optical amplifier that is provided on the substrate, receives combined light from the optical combiner, and amplifies and outputs the combined light.

12. An optical modulator comprising:
an optical splitter configured to split input light into first to N-th lights, N being an integer of two or more;
first to N-th optical modulators of an electro-absorption type configured to modulate, by modulation signals, the first to N-th lights output from the optical splitter, respectively; and
an optical combiner configured to combine the first to N-th lights output from the first to N-th optical modulators,
wherein an optical power of the n-th light is 2^{(n - 1)} times an optical power of the first light, n being 2, ..., N, and
first to N-th binary electrical signals obtained by decomposing a binary electrical signal are provided to the first to N-th optical modulators, respectively, as the modulation signals such that output light from the optical combiner includes a multilevel optical signal.
